(19) United States
(12) Patent Application Publication
(10) Pub. No.: US 2026/0319897 A1
(43) Pub. Date: Oct. 15, 2026

(54) LEVERAGE A POWER ADAPTER FOR ROOT CAUSE ANALYSIS OF A SYSTEM FAILURE

(71) Applicant: DELL PRODUCTS L.P., Round Rock, TX (US)

(72) Inventors: Venkata Rama Krishna Rao Atta, Hyderabad (IN); Ibrahim Sayyed, Georgetown, TX (US); Marcin Nowak, Prosper, TX (US)

(21) Appl. No.: 19/067,908

(22) Filed: Mar. 2, 2025

(51) Int. Cl. G06F 11/14; G06F 11/07

(52) U.S. Cl. CPC G06F 11/1471; G06F 11/079

(57) ABSTRACT

An information handling system, configured to monitor for an error message and in response to detecting a failure condition, identify the failure condition and generate a log associated with the failure condition. The information handling system is also configured to transmit the log to a power adapter, wherein the log is stored in a volatile memory of the power adapter.

### FIELD OF THE DISCLOSURE

The present disclosure generally relates to information handling systems, and more particularly relates to leverage a power adapter for root cause analysis of a system failure.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system, configured to monitor for an error message and in response to detecting a failure condition, identify the failure condition and generate a log associated with the failure condition. The information handling system is also configured to transmit the log to a power adapter, wherein the log is stored in a volatile memory of the power adapter.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system to leverage a power adapter for root cause analysis of a system failure, according to an embodiment of the present disclosure;

FIGS. 2-5 are block diagrams of methods to leverage a power adapter for root cause analysis of a system failure, according to an embodiment of the present disclosure; and

FIG. 6 is a block diagram of an information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

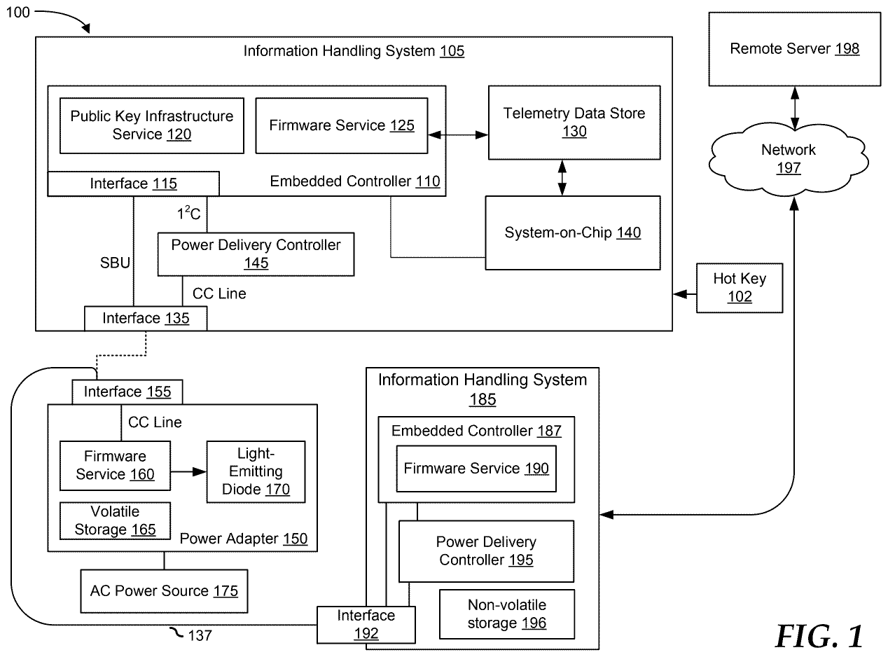

FIG. 1 illustrates an environment 100 to leverage a power adapter for root cause analysis of a system failure, according to an embodiment of the present disclosure. Environment 100 includes an information handling system 105, a power adapter 150, an alternating current (AC) power source 175, an information handling system 185, a network 197, and a remote server 198. Information handling system 105 includes an embedded controller, a power delivery controller 145, an interface 135, a telemetry data store 130, and a system-on-chip (SoC) 140. Embedded controller 110 includes an interface 115, a public key infrastructure service 120, and a firmware service 125. Power adapter 150 includes a firmware service 160, a volatile storage 165, and a light-emitting diode 170. Information handling system 185 includes an embedded controller 187, an interface 192, a power delivery controller 195, and a non-volatile storage 196. Embedded controller 187 includes a firmware service 190.

Information handling system 105 may be coupled with power adapter 150 that is plugged in AC power source 175, which may be a wall socket. Power adapter 150 may be coupled information handling system 185 subsequent to disconnecting from information handling system 105 without unplugging power adapter 150 from AC power source 175. Information handling system 185 may be coupled to remote server 198 via network 197. Embedded controller 110 may be coupled to power delivery controller 145, interface 135, telemetry data store 130, and SoC 140. Interface 155 may be coupled to firmware service 160 which is coupled to volatile storage 165 and light-emitting diode 170. Interface 192 may be coupled with embedded controller 187 and power delivery controller 195. Embedded controller 187 and power delivery controller 195 may be coupled with non-volatile storage 196. However, any variety of connections between components of environment 100 and within each component is envisioned as falling within the scope of the present disclosure. In addition, connections between components may be omitted for descriptive clarity.

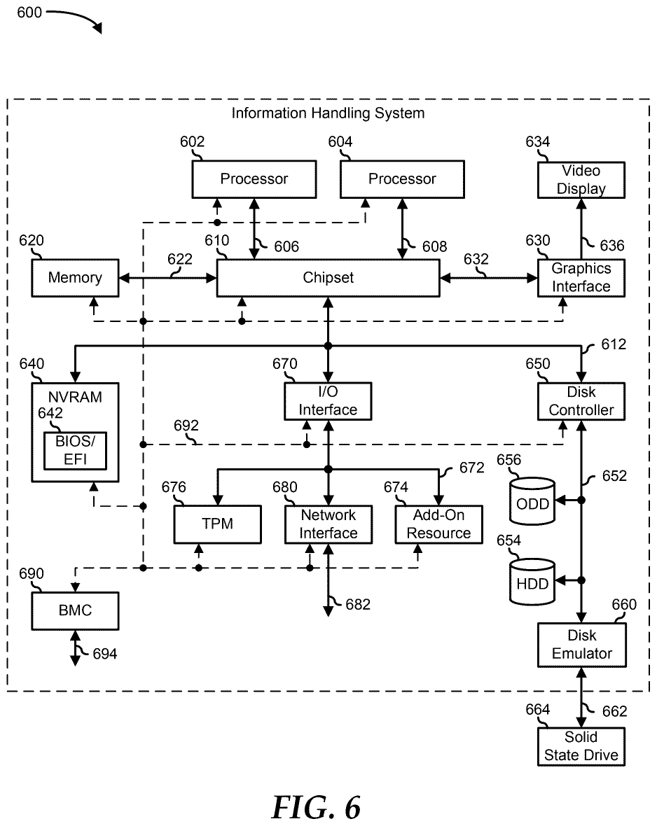

Each of embedded controller 110 and power delivery controller 145 may include a processor, which can perform operations of the embedded controller and power delivery controller 145, respectively. In addition, SoC 140 may perform operations associated with information handling system 105 and its components. Similarly, embedded controller 187 and power delivery controller 195 may include a processor that can perform operations of embedded controller 187 and power delivery controller 195, respectively. In addition, information handling system 185 may include a SoC that can perform operations associated with information handling system 185 and its components. One of skill in the art will appreciate that the functions performed by the SoC provided herein, such as SoC 140 may be performed by a processor instead that is similar to processors 602 and 604 of FIG. 6.

Information handling systems 105 and 185, which are similar to information handling system 600 of FIG. 6, may be a personal computer, a desktop computer system, a laptop computer system, a server computer system, a mobile device, a tablet computing device, a personal digital assistant, a consumer electronic device, an electronic music player, an electronic camera, an electronic video player, a wireless access point, a network storage device, or any other suitable computing device. Information handling systems 105 and 185 may also be a portable information handling system that may include a laptop, a notebook, a smartphone, a tablet, or a personal digital assistant, among others. In this example, information handling system 105 may have encountered a system failure, such as a system hang or a no boot/no power on self-test (POST)/no video (NB/NP/NV) situation. However, information handling system 185 may be a working system of a user or a service technician to aid in analyzing the system failure encountered by information handling system 105.

Embedded controller 110, which is similar to BMC 690 of FIG. 6, may include any system, device, or apparatus, such as a microcontroller on a motherboard of information handling system 105. Embedded controller 110 may be configured to support original equipment manufacturer (OEM) specific implementations to manage and/or control one or more components of information handling system 105. Embedded controller 110 may include interface 115 configured with a universal asynchronous receiver/transmitter (UART) or Inter-Integrated Circuit (I²C) port connection with interface 135 through a sideband use (SBU) bus. The I²C bus may be coupled to interface 135 via power delivery controller 145 and through one or more configuration channel (CC) lines, such as CC1 and/or CC2. Typically, the SBU bus is unused. Embedded controller 110 and/or firmware service 125 may convert the SBU bus into a serial bus by sending a signal to power adapter 150 to change the power adapter's current mode and mode of the SBU bus to a special mode. This special mode may allow firmware service 125 to use the SBU bus for transmitting telemetry data stored in telemetry data store 130 to power adapter 150. In another embodiment, the special mode of power adapter 150 may allow embedded controller 110 and/or firmware service 125 to utilize the I²C connection via power delivery controller 145 to transmit the telemetry data to power adapter 150. Embedded controller 110 includes a public key infrastructure service 120 which may be used to authenticate logs, vendor data messages and/or other data transmitted or received by embedded controller 110. For example, embedded controller 110 may encrypt the logs and/or vendor data messages prior to transmission.

Embedded controller 110 includes a firmware service 125, which may be configured to monitor SoC 140, voltage regulators, among others and receive, fetch, or collect related telemetry data. For example, embedded controller may collect basic input/output system (BIOS) attribute data or BIOS forensic data. As such, firmware service 125 may also be referred to as a SoC monitor service. The telemetry data may be collected subsequent to activating a UEFI telemetry program to obtain BIOS attribute data. The telemetry data may include but is not limited to hardware telemetry data, application telemetry data, firmware data, or the like. Telemetry data may also include data associated with the boot process, health of BIOS firmware, CPU core bottleneck issues, memory bottleneck issues, voltage regulator configuration, power sequence process, and the like. The telemetry data may be stored in telemetry data store 130. In another embodiment, the collection of the telemetry data and/or generating a log may be triggered by a hotkey 102 that the user has pressed. Telemetry data store 130 may be a non-volatile memory, a partition in an SPI flash device, or a data storage device that is accessible by embedded controller 110 and SoC 140. Telemetry data store 130 may be configured to store one or more data sets such as alerts, mapping tables, accounts associated with the alerts, support tickets, etc. associated with embedded controller 110 and SoC 140.

Telemetry data store 130 may be based on one or more data platforms such as relational databases, HADOOP™, etc. The data set may also be stored in various formats such as text files, extensible markup language (XML) files, comma-separated values (CSV) files, etc. Telemetry data store 130 may be in a persistent storage device such as a solid-state disk, hard disk drive, magnetic tape library, optical disk drive, magneto-optical disk drive, compact disk drive, compact disk array, disk array controller, and/or any computer-readable medium operable to store data. In another example, telemetry data store 130 may be similar to memory 620 of FIG. 6 or a partition in a memory similar to non-volatile random access memory (NVRAM) 640 of FIG. 6.

Interface 135 may be a cable interface, such as a universal serial bus (USB) Type-C port, configured to support a cable 137 which may be coupled to interface 155. Cable 137 may be a USB Type-C cable or similar wherein its specified power rating may conform to a Type-C specification. For example, USB Type-C interfaces include two pins on the connector, CC1 and CC2, that are used to establish and manage the source-to-sink connection. Accordingly, cable 137 may support device detection, interface configuration, communication, and power delivery mechanisms according to USB Type-C standard. As such, cable 137 may allow the transport of data and direct current (DC) power between various devices that are connected using USB Type-C ports and USB Type-C connectors. In this example, interface 155 may also be a USB Type-C port.

Information handling system 105 can include processing resources for executing machine-executable code, such as a processor, a programmable logic array (PLA), an embedded device such as SoC 140, or other control logic hardware. For example, SoC 140 may be a processor similar to processors 602 and 604 of FIG. 6 with a platform controller hub (PCH). In one embodiment, SoC 140 may be configured to execute the BIOS at the beginning of every boot.

Power delivery controller 145 may be any system, device, or apparatus configured to negotiate power and data contracts, such as a USB Type-C power delivery controller. For example, power delivery controller 145 may be configured to enable or disable protocols supported by USB Type-C port such as interfaces 135 and 155. In a particular example, power delivery controller 145 may be configured to manage connection and information exchange between embedded controller 110 and power adapter 150. Power delivery controller 145 may also be configured to determine power and data inputs and/or outputs that are available in data lines. For example, POST messages and/or other data may be transmitted from embedded controller 110 to power delivery controller 145 via an I²C bus.

Power delivery controller 145 can translate the POST messages and/or other data into vendor-defined messages that can be transmitted through the CC lines. Power delivery controller 145 may then transmit the vendor-defined messages to power adapter 150 via interfaces 135 and 155 through CC lines, such as when cable 137 is connected to interface 135. Firmware service 160 may receive the POST messages and/or other data and store the POST messages and/or other data in volatile storage 165. The POST messages and/or other data may be stored as data packets in volatile storage 165. The data packets may be retained in volatile storage 165 while the power adapter is plugged into AC power source 175.

In addition, firmware service 160 may turn on light-emitting diode 170 to signal that it received and/or stored the POST messages and/or other data in volatile storage 165, which can also indicate that the POST messages and/or other data in volatile storage 165 is ready to be collected. In various embodiments, power delivery controller 145 may be implemented by program instructions executing on a local processor or microcontroller by dedicated hardware circuitry or by a combination of hardware and software elements to perform the functionality of power delivery controller 145.

Information handling system 105 may be connected to AC power source 175 via power adapter 150. For example, cable 137 may connect interface 155 with interface 135. Power adapter 150 may be any device or apparatus configured to couple information handling system 105 or information handling system 185 to power sources and convert power from those power sources to a power level that is appropriate for use in operating the information handling system and/or charging the battery for the information handling system. Information handling systems typically support multiple power states that correspond to power states defined in Advanced Configuration and Power Interface (ACPI) specification, such as a full shutdown (S5) state and a mechanical off (G3) state.

A critical component of modern information handling systems is BIOS, which may comprise boot firmware configured to be the first code executed by a processor or SoC of an information handling system when the information handling system is booted and/or powered on and serves to initialize information handling resources of the information handling system. Embedded controller 110 may be configured to perform a power sequence when the information handling system 105 is powered on, which includes configuring one or more voltage regulators of the information handling system according to a pre-defined sequence. When embedded controller 110 fails to configure the voltage regulator, which results in a no-power state, embedded controller 110 may send a voltage regulator configuration failure information with an error code to power delivery controller 145 over a System Management Bus (SMBus) or I²C bus. Power delivery controller 145 may then send this error code along with other data or information to power adapter 150, such as via CC lines using vendor-defined messages for temporary storage. Power delivery controller 145 may use power, such as from alternating current (AC) power source 175, from connected power adapter 150.

After a successful power-on sequence, embedded controller 110 may be configured to power on SoC 140 to start a POST process. Embedded controller 110 may also start monitoring the POST status of SoC 140. The POST process may be designed with detailed boot markers at each step of the POST process. SoC 140 may be configured to share a boot marker code with embedded controller 110 when SoC 140 passes the associated boot marker. When the POST process gets stuck at one of the boot markers, embedded controller 110 may identify a boot failure associated with the issue. Embedded controller 110 may then transmit a POST failure boot marker code and associated telemetry data over to power delivery controller 145 via the SMBus. In addition, embedded controller 110 may store the POST failure boot marker code and the telemetry data at telemetry data store 130. For example, embedded controller 110 may include a telemetry service to transmit and receive telemetry data between SoC 140 and embedded controller 110. Power delivery controller 145 may also send the POST failure boot marker code, the telemetry data among other data or information to power adapter 150 over the CC lines using custom vendor-defined messages. The POST failure boot marker code and the telemetry data may be encrypted via public key infrastructure service 120 prior to transmission. The POST failure boot marker code, the telemetry data, and/or other data may be added to the log generated by embedded controller 110 prior to transmission.

Users of an information handling system may experience a situation in which the BIOS fails to complete POST and fails to reach a point of execution in which video drivers of the information handling system execute, a situation often referred to as an NB/NP/NV situation.

Reported NB/NP/NV errors may be attributable to various issues including, for example, BIOS boot block corruption that occurs during update or recovery, such as flash write cycle, power failure, etc. Diagnosis of the cause of the NB/NP/NV situation is often difficult, as diagnosis may rely on a user correctly observing diagnostic blink patterns of light-emitting diode indicators of the information handling system and correctly looking up the meaning of the numerical code associated with the blink patterns, which may lead to bad user experience as well as technical support requests to a vendor of the information handling system. Because of the current state of the information handling system, a user or service technician may not be able to use diagnostic tools to analyze log or telemetry data associated with the information handling system with the NB/NP/NV situation.

Often, using known approaches, when the NB/NP/NV situation occurs and built-in BIOS recovery is unable to recover, the solution is either a costly motherboard replacement or a re-flash of a new BIOS image to Serial Peripheral Interface (SPI) read-only memory (ROM) in which BIOS is stored, which may lead to loss of a user's persistent data. This is generally because no support log and/or telemetry data is available for service technicians to analyze and use to perform diagnostics. As such, the service technicians need to fetch telemetry from the failed system to do a targeted forensic failure analysis before making an appropriate decision for part replacement and avoid NB/NP/NV cases. Accordingly, the present disclosure provides a system and method to leverage a power adapter to store a log for root cause analysis of a system failure. By connecting the power adapter to another information handling system, a firmware service of the other information handling system may retrieve the log from the power adapter for analysis. For example, diagnostics tools may be utilized with the other information handling system to determine a root cause and recovery steps of the failure associated with the first information handling system.

Power adapter 150, which is connected to information handling system 105, may store POST failure boot marker code and associated telemetry data in volatile storage 165 as long as power adapter 150 is connected to AC power source 175, such as a wall socket. When a user disconnects cable 137 from interface 135 and connects it to interface 192, firmware service 190 may fetch the log that includes the error code, POST failure boot marker code, BIOS forensic data, and associated telemetry data among others from volatile storage 165 of power adapter 150 and store the aforementioned in non-volatile storage 196. Embedded controller 187 may authenticate and/or decrypt the collected log prior to storage. The service application may then dial a service center over a data path. Power delivery controller 195 may decode or translate the data packets received of the log from power adapter 150 and transmit the log to firmware service 190. In addition, firmware service 190 may transmit the log to a data store or memory of remote server 198 via network 197. A service technician at the service center may analyze the log.

Afterward, the service technician may then be able to assist the user with the boot issue.

Those of ordinary skill in the art will appreciate that the configuration, hardware, and/or software components of environment 100 depicted in FIG. 1 may vary. For example, the illustrative components within environment 100 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

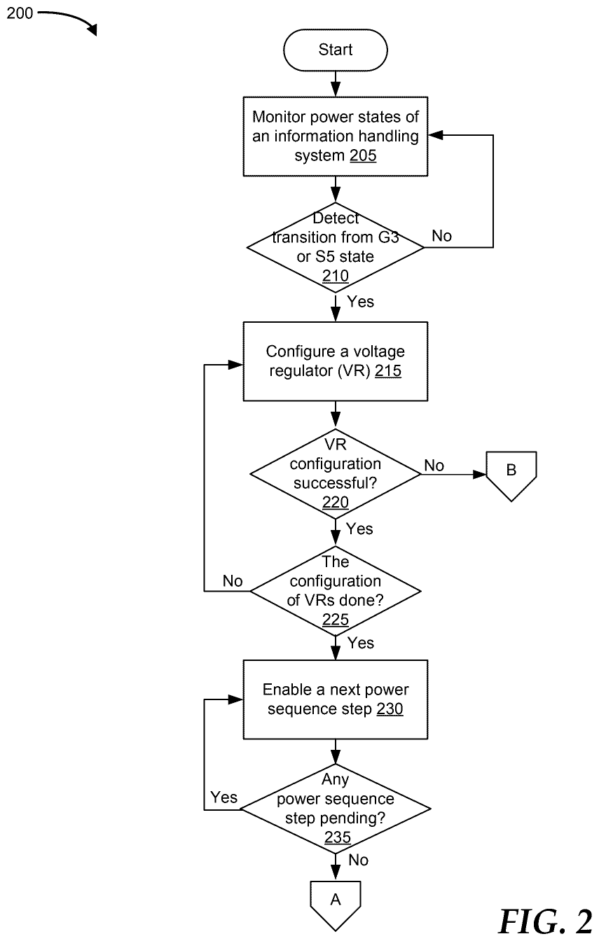

FIG. 2 illustrates a portion of a flowchart of a method 300 to leverage a power adapter for root cause analysis of a system failure, according to an embodiment of the present disclosure. Method 200 may be performed by any suitable component of environment 100 including, but not limited to, embedded controller 110, SoC 140, and power delivery controller 145 of FIG. 1.

While embodiments of the present disclosure are described in terms of the components of environment 100 of FIG. 1, it should be recognized that other components may be utilized to perform the described method. It will be readily appreciated that not every block set forth in this flowchart is always necessary and that certain blocks of the methods may be combined, performed simultaneously, in a different order, or perhaps omitted, without varying from the scope of the disclosure. One of skill in the art will appreciate that this flow chart explains a typical example, which can be extended to applications or services in practice.

Method 200 typically starts at a block 205 where an embedded controller may monitor power states of an information handling system. At decision block 210, the embedded controller may determine whether it detects that the information handling system is transitioning from a mechanical shutdown (G3) state or a full shutdown (S5) state to a working state. For example, the embedded controller may have received a wake-up event. To transition to the working state from the S5 and G3 states generally requires a boot process. If the embedded controller detects that the information handling system is transitioning from the G3 state or the S5 state to a working state, then the “YES” branch is taken, and the method may proceed to a block 215. If the embedded controller does not detect that the information handling system is transitioning from the G3 state or the S5 state to a working state, then the “NO” branch is taken, and the method may proceed to block 205.

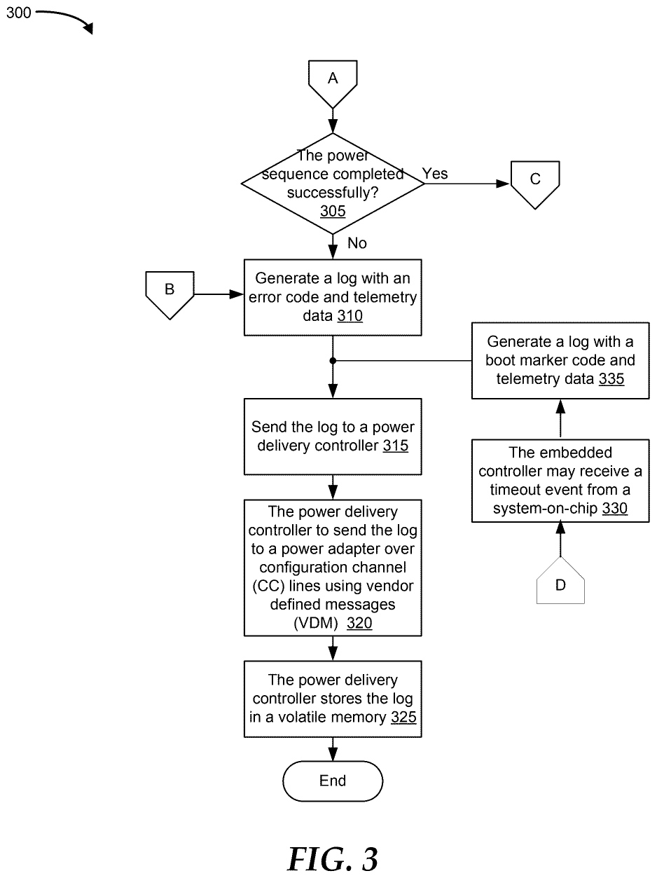

At block 215, a power sequence may be initiated by an embedded controller, wherein the power sequence includes enabling and/or configuring one or more voltage regulators. The method may proceed to a decision block 220 where the embedded controller may determine whether the configuration of the voltage regulator is successful. If the configuration of the voltage regulator is successful, then the “YES” branch is taken, and the method may proceed to a decision block 225. If the configuration of the voltage regulator is not successful, then the “NO” branch is taken, and the method may proceed to a decision block 310 of FIG. 3.

At decision block 225, the embedded controller may determine whether the configuration of each of the voltage regulators is done, such that each one of the voltage regulators of the information handling system has been configured successfully. If the configuration of each of the voltage regulators is done, then the “YES” branch is taken, and the method may proceed to a block 230. If the configuration of each of the voltage regulators is not done, then the “NO” branch is taken, and the method may proceed to block 215. At block 230, the embedded controller may enable a next power sequence step. For example, the next power sequence step may include enabling power rails associated with the information handling system. The method may proceed to a decision block 235, where the embedded controller may determine if there is any power sequence step that is pending. If there is a pending power sequence step, then the “YES” branch is taken, and the method may proceed to block 230. If there is no pending power sequence step, then the “NO” branch is taken, and the method may proceed to a decision block 305 of FIG. 3.

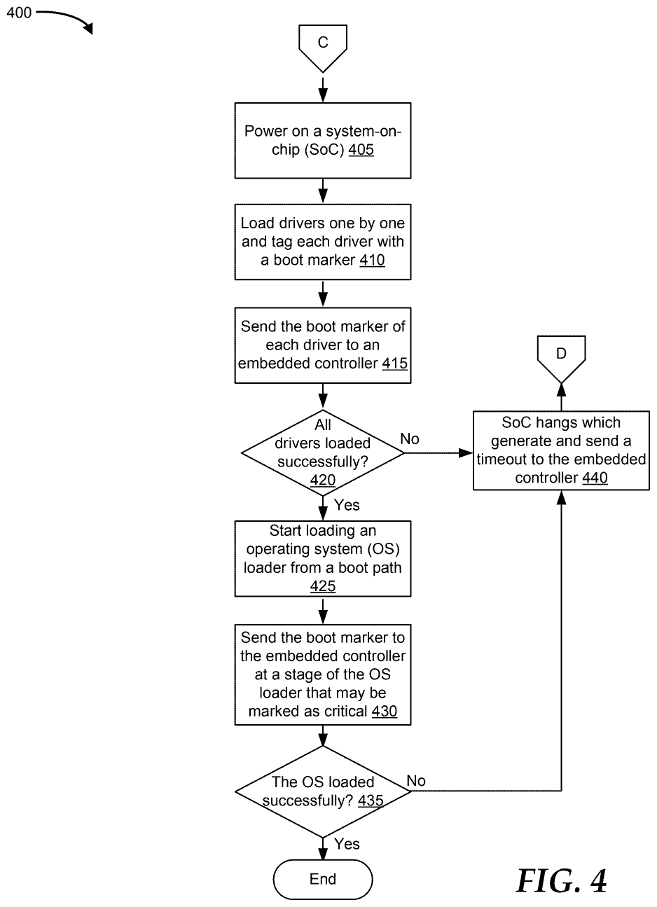

FIG. 3 illustrates a portion of a flowchart of a method 300, which is a continuation of method 200 of FIG. 2. Method 300 typically starts at decision block 305 where the embedded controller may determine whether the power sequence is completed successfully. If the power sequence is completed successfully, then the “YES” branch is taken, and the method may proceed to a block 405 of FIG. 4. If the power sequence is not completed successfully, then the “NO” branch is taken, and the method may proceed to a block 310.

At block 310, the embedded controller may generate a log with an error code. The embedded controller may also identify a failure condition associated with the error code, such as voltage regulator configuration failure and collect telemetry data associated with the failure condition and include the telemetry data in the log. The method may proceed to block 315 where the embedded controller may send the log to a power delivery controller, such as over an I²C bus. The method may proceed to a block 320, where the power delivery controller may send the log to a power adapter over CC lines using vendor-defined messages. The embedded controller may direct the power delivery controller to enable the power adapter to operate in a special mode to allow the log transmission prior to sending the log over the CC lines. The method may proceed to a block 325 where the power delivery controller may store the log, such as in a log file in a volatile memory of the power adapter. Afterward, the method ends.

At a block 330, the embedded controller may receive a timeout event from a SoC. The embedded controller may be configured to monitor POST messages, such as the boot marker(s), and responsive to detecting a POST error message indicative of a POST error condition including, as an example, an NB/NP/NV condition, activating a Unified Extensible Firmware Interface (UEFI) telemetry program to obtain BIOS attribute data, telemetry data, and/or POST messages associated with the POST error and store the telemetry data and/or POST messages in a telemetry data store. At block 335, the embedded controller may generate a log with an error code and telemetry data. The log generation may be triggered by the timeout event. The log may be appended to the log generated at block 310. The log may be stored in a non-volatile memory similar to telemetry data store 130 of FIG. 1. The method may proceed to block 315.

FIG. 4 illustrates a portion of a flowchart of a method 400, which is a continuation of method 300 of FIG. 3. Method 400 typically starts at a block 405 where the embedded controller may power on a SoC or a processor. The method may proceed to block 410, where the SoC or the processor may load drivers one by one with a boot marker associated with each of the loaded drivers. The method may proceed to block 415 where the SoC or the processor may send the boot marker of each driver to an embedded controller SoC monitor service. The method may proceed to decision block 420 where the SoC or the processor may determine whether the drivers were loaded successfully. If the drivers were loaded successfully, then the “YES” branch is taken, and the method may proceed to block 425. If the drivers were not loaded successfully, then the “NO” branch is taken, and the method may proceed to a block 440.

At block 425, the SoC or processor may start loading an operating system loader from a booth path. The method may proceed to block 430 where the SoC or processor may send the boot marker of each stage that may be deemed critical by the operating system loader to the embedded controller. The stages may be assigned as critical during a development process of the BIOS. The method may proceed to decision block 435 where the SoC or the processor may determine whether the operating system loaded successfully. If the operating system is loaded successfully, then the “YES” branch is taken, and the method ends. If the operating system is not loaded successfully, then the “NO” branch is taken, and the method may proceed to block 440. At block 440, the SoC may hang which may generate a timeout event which may be sent to the embedded controller SoC monitor service, wherein the timeout includes an error code. The embedded controller may identify a failure condition associated with the error code, such as a driver execution environment (DXE) driver corruption issue, memory handoff mapping issue, an NB/NP/NV condition, corrupted master boot record (MBR), faulty power supply, damaged motherboard, etc. The embedded controller may collect forensic data associated with the error code and/or failure condition. The timeout may be triggered if the operating system hangs and is transmitted along with the collected forensic data to the embedded controller so that the forensic data can be written by the embedded controller to a non-volatile storage. The timeout is an unrecoverable error or failure condition that may cause system pathways to be blocked. The method may proceed to block 330 of FIG. 3.

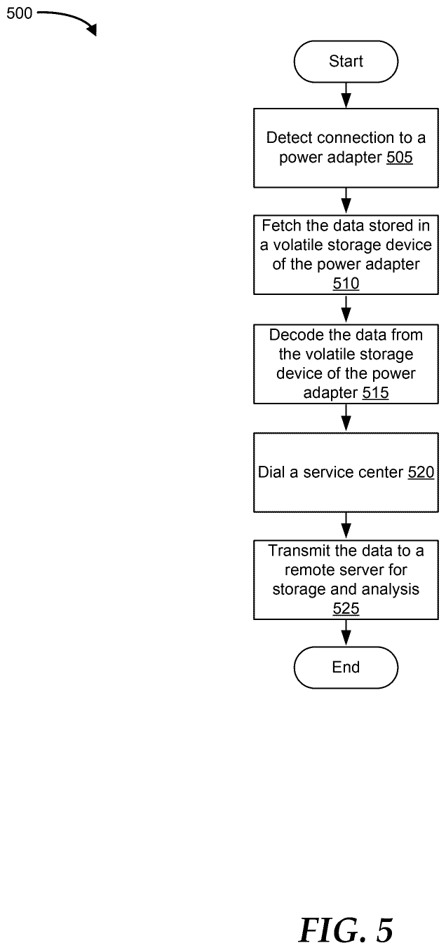

FIG. 5 illustrates a portion of a flowchart of a method 500 to leverage a power adapter for root cause analysis of a system failure, according to an embodiment of the present disclosure. Method 500 may be performed by any suitable component of environment 100 including, but not limited to, embedded controller 187 and power delivery controller 195 of FIG. 1. While embodiments of the present disclosure are described in terms of the components of environment 100 of FIG. 1, it should be recognized that other components may be utilized to perform the described method. It will be readily appreciated that not every block set forth in this flowchart is always necessary and that certain blocks of the methods may be combined, performed simultaneously, in a different order, or perhaps omitted, without varying from the scope of the disclosure. One of skill in the art will appreciate that this flow chart explains a typical example, which can be extended to applications or services in practice.

Method 500 typically starts at block 505 where a power delivery controller detects a connection of a cable to an interface of an information handling system. A connection negotiation may occur between the power delivery controller and the power adapter using the CC lines. As part of the negotiation, the power adapter may be configured to provide information that it has some log or data for diagnosis. The power delivery controller may transmit the information to a firmware service of an embedded controller that the connection is detected. The method may proceed to a block 510 where the firmware service may fetch or collect the log that includes the POST message and/or other data stored in the volatile storage of the power adapter through the CC lines. The method may proceed to block 515 where the firmware service may receive the log as data packets, decode and/or decrypt data packets prior to storage in a non-volatile storage of the information handling system. The method may proceed to block 520 where the embedded controller may dial a service center for a service technician to perform diagnostics and analyze the log associated with the failed information handling system. The method may proceed to block 525, where the embedded controller or firmware service may transmit the log with the POST message and/or other data collected from the volatile storage device of the power adapter to a remote server for analysis and/or storage. Afterwards, the method ends.

FIG. 6 illustrates an embodiment of an information handling system 600 including processors 602 and 604, a chipset 610, a memory 620, a graphics adapter 630 connected to a video display 634, a NVRAM 640 that includes a basic input and output system/extensible firmware interface (BIOS/EFI) module 642, a disk controller 650, a hard disk drive (HDD) 654, an optical disk drive 656, a disk emulator 660 connected to a solid-state drive (SSD) 664, an input/output (I/O) interface 670 connected to an add-on resource 674 and a trusted platform module (TPM) 676, a network interface 680, and a baseboard management controller (BMC) 690. Processor 602 is connected to chipset 610 via processor interface 606, and processor 604 is connected to the chipset via processor interface 608. In a particular embodiment, processors 602 and 604 are connected together via a high-capacity coherent fabric, such as a HyperTransport link, a QuickPath Interconnect, or the like. Chipset 610 represents an integrated circuit or group of integrated circuits that manage the data flow between processors 602 and 604 and the other elements of information handling system 600. In a particular embodiment, chipset 610 represents a pair of integrated circuits, such as a northbridge component and a southbridge component. In another embodiment, some or all of the functions and features of chipset 610 are integrated with one or more of processors 602 and 604.

Memory 620 is connected to chipset 610 via a memory interface 622. An example of memory interface 622 includes a Double Data Rate (DDR) memory channel and memory 620 represents one or more DDR Dual In-Line Memory Modules (DIMMs). In a particular embodiment, memory interface 622 represents two or more DDR channels. In another embodiment, one or more of processors 602 and 604 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 620 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, and the like. Graphics adapter 630 is connected to chipset 610 via a graphics interface 632 and provides a video display output 636 to a video display 634. An example of a graphics interface 632 includes a Peripheral Component Interconnect-Express (PCIe) interface and graphics adapter 630 can include a four-lane (×4) PCIe adapter, an eight-lane (×8) PCIe adapter, a 16-lan (×16) PCIe adapter, or another configuration, as needed or desired. In a particular embodiment, graphics adapter 630 is provided down on a system printed circuit board (PCB). Video display output 636 can include a Digital Video Interface (DVI), a High-Definition Multimedia Interface (HDMI), a DisplayPort interface, or the like, and video display 634 can include a monitor, a smart television, an embedded display such as a laptop computer display, or the like.

NVRAM 640, disk controller 650, and I/O interface 670 are connected to chipset 610 via an I/O channel 612. An example of I/O channel 612 includes one or more point-to-point PCIe links between chipset 610 and each of NVRAM 640, disk controller 650, and I/O interface 670. Chipset 610 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface, a Universal Serial Bus (USB), another interface, or a combination thereof. NVRAM 640 includes BIOS/EFI module 642 that stores machine-executable code (BIOS/EFI code) that operates to detect the resources of information handling system 600, to provide drivers for the resources, to initialize the resources, and to provide common access mechanisms for the resources. The functions and features of BIOS/EFI module 642 will be further described below.

Disk controller 650 includes a disk interface 652 that connects the disc controller to a hard disk drive (HDD) 654, to an optical disk drive (ODD) 656, and to disk emulator 660. An example of disk interface 652 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 660 permits SSD 664 to be connected to information handling system 600 via an external interface 662. An example of external interface 662 includes a USB interface, an institute of electrical and electronics engineers (IEEE) 1394 (Firewire) interface, a proprietary interface, or a combination thereof. Alternatively, SSD 664 can be disposed within information handling system 600.

I/O interface 670 includes a peripheral interface 672 that connects the I/O interface to add-on resource 674, to TPM 676, and to network interface 680. Peripheral interface 672 can be the same type of interface as I/O channel 612 or can be a different type of interface. As such, I/O interface 670 extends the capacity of I/O channel 612 when peripheral interface 672 and the I/O channel are of the same type, and the I/O interface translates information from a format suitable to the I/O channel to a format suitable to the peripheral interface 672 when they are of a different type. Add-on resource 674 can include a data storage system, an additional graphics interface, a network interface card (NIC), a sound/video processing card, another add-on resource, or a combination thereof. Add-on resource 674 can be on a main circuit board, on separate circuit board, or add-in card disposed within information handling system 600, a device that is external to the information handling system, or a combination thereof.

Network interface 680 represents a network communication device disposed within information handling system 600, on a main circuit board of the information handling system, integrated onto another component such as chipset 610, in another suitable location, or a combination thereof. Network interface 680 includes a network channel 682 that provides an interface to devices that are external to information handling system 600. In a particular embodiment, network channel 682 is of a different type than peripheral interface 672 and network interface 680 translates information from a format suitable to the peripheral channel to a format suitable to external devices.

In a particular embodiment, network interface 680 includes a NIC or host bus adapter (HBA), and an example of network channel 682 includes an InfiniBand channel, a Fibre Channel, a Gigabit Ethernet channel, a proprietary channel architecture, or a combination thereof. In another embodiment, network interface 680 includes a wireless communication interface, and network channel 682 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 682 can be connected to an external network resource (not illustrated). The network resource can include another information handling system, a data storage system, another network, a grid management system, another suitable resource, or a combination thereof.

BMC 690 is connected to multiple elements of information handling system 600 via one or more management interface 692 to provide out-of-band monitoring, maintenance, and control of the elements of the information handling system. As such, BMC 690 represents a processing device different from processor 602 and processor 604, which provides various management functions for information handling system 600. For example, BMC 690 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 690 can vary considerably based on the type of information handling system. BMC 690 can operate in accordance with an Intelligent Platform Management Interface (IPMI). Examples of BMC 690 include an Integrated Dell® Remote Access Controller (iDRAC).

Management interface 692 represents one or more out-of-band communication interfaces between BMC 690 and the elements of information handling system 600 and can include an Inter-Integrated Circuit (I²C) bus, a SMBuS, a Power Management Bus (PMBuS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 600, that is apart from the execution of code by processors 602 and 604 and procedures that are implemented on the information handling system in response to the executed code.

BMC 690 operates to monitor and maintain system firmware, such as code stored in BIOS/EFI module 642, option ROMs for graphics adapter 630, disk controller 650, add-on resource 674, network interface 680, or other elements of information handling system 600, as needed or desired. In particular, BMC 690 includes a network interface 694 that can be connected to a remote management system to receive firmware updates, as needed or desired.

Here, BMC 690 receives the firmware updates, stores the updates to a data storage device associated with the BMC, and transfers the firmware updates to NVRAM of the device or system that is the subject of the firmware update, thereby replacing the currently operating firmware associated with the device or system, and reboots information handling system, whereupon the device or system utilizes the updated firmware image.

BMC 690 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 690, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by an “F2” boot option, or another protocol or API, as needed or desired.

In a particular embodiment, BMC 690 is included on a main circuit board (such as a baseboard, a motherboard, or any combination thereof) of information handling system 600 or is integrated into another element of the information handling system such as chipset 610, or another suitable element, as needed or desired. As such, BMC 690 can be part of an integrated circuit or a chipset within information handling system 600. An example of BMC 690 includes an iDRAC, or the like. BMC 690 may operate on a separate power plane from other resources in information handling system 600. Thus, BMC 690 can communicate with the management system via network interface 694 while the resources of information handling system 600 are powered off. Here, information can be sent from the management system to BMC 690 and the information can be stored in a RAM or NVRAM associated with the BMC. Information stored in the RAM may be lost after power-down of the power plane for BMC 690, while information stored in the NVRAM may be saved through a power-down/power-up cycle of the power plane for the BMC.

Information handling system 600 can include additional components and additional busses, not shown for clarity. For example, information handling system 600 can include multiple processor cores, audio devices, and the like. While a particular arrangement of bus technologies and interconnections is illustrated for the purpose of an example, one of skill will appreciate that the techniques disclosed herein are applicable to other system architectures.

Information handling system 600 can include multiple central processing units (CPUs) and redundant bus controllers. One or more components can be integrated together. Information handling system 600 can include additional buses and bus protocols, for example, I²C and the like. Additional components of information handling system 600 can include one or more storage devices that can store machine-executable code, one or more communications ports for communicating with external devices, and various input and output (I/O) devices, such as a keyboard, a mouse, and a video display.

For purposes of this disclosure, information handling system 600 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 600 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 600 can include processing resources for executing machine-executable code, such as processor 602, a programmable logic array (PLA), an embedded device such as a SoC, or other control logic hardware. Information handling system 600 can also include one or more computer-readable media for storing machine-executable code, such as software or data.

As used herein, when two or more elements are referred to as “coupled” it indicates that the two or more elements are in electronic communication, mechanical communication, including thermal and fluidic communication as applicable, whether connected indirectly or directly, with or without intervening elements.

Although FIG. 2, FIG. 3, and FIG. 4 show example blocks of method 200, method 300, and method 400 in some implementations, method 200, method 300, and method 400 may include additional blocks, fewer blocks, different blocks, or differently arranged blocks than those depicted in FIG. 2, FIG. 3, and FIG. 4. Those skilled in the art will understand that the principles presented herein may be implemented in any suitably arranged processing system. Additionally, or alternatively, two or more of the blocks of method 200, method 300, and method 400 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded in a larger chip), a card (such as a Peripheral Component Interface (PCI) card, a PCI-express card, a Personal Computer Memory Card International Association (PCMCIA) card, or other such expansion card), or a system (such as a motherboard, a SoC, or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

1. A method comprising:
monitoring an information handling system, by a processor, to detect an error message;
in response to detecting the error message, identifying a failure condition associated with the error message;
generating a log associated with the failure condition;
transmitting the log to a power adapter, wherein the log is stored in a volatile memory of the power adapter; and
changing a current mode of the power adapter prior to the transmitting of the log to the power adapter.

2. The method of claim 1, further comprising encrypting the log prior to the transmitting of the log to the power adapter.

3. The method of claim 1, wherein the transmitting of the log is performed via a vendor-defined message.

4. The method of claim 1, wherein the transmitting of the log is performed using configuration channel lines.

5. The method of claim 1, further comprising subsequent to connecting a cable of the power adapter to another information handling system, collecting, by the another information handling system, the log stored in the volatile memory of the power adapter.

6. The method of claim 5, further comprising subsequent to the collecting of the log from the power adapter, dialing a service center.

7. The method of claim 5, further comprising subsequent to the collecting of the log from the power adapter, transmitting the log to a remote server.

8. The method of claim 5, further comprising decoding data packets from the collecting of the log.

9. The method of claim 1, wherein the log includes an error code associated with configuring a voltage regulator.

10. The method of claim 1, wherein the log includes a boot marker code and telemetry data.

11. An information handling system, comprising:
a processor; and
a memory coupled to the processor, the memory having program instructions stored thereon that, upon execution, cause the processor to:
monitor the information handling system to detect an error message;
in response to detecting the error message, identify a failure condition associated with the error message;
generate a log associated with the failure condition;
transmit the log to a power adapter, wherein the log is stored in a volatile memory of the power adapter; and
dial a service center subsequent to collection of the log from the power adapter.

12. The information handling system of claim 11, wherein the log is transmitted via a vendor-defined message.

13. The information handling system of claim 11, wherein the log is transmitted using configuration channel lines.

14. The information handling system of claim 11, wherein the program instructions further cause the processor to collect by another information handling system, the log stored in the volatile memory of the power adapter, subsequent to connecting a cable of the power adapter to the another information handling system.

15. The information handling system of claim 11, wherein the program instructions further cause the processor to encrypt the log prior to the transmit of the log to the power adapter.

16. A non-transitory computer-readable medium to store instructions that are executable to perform operations comprising:
monitoring an information handling system to detect an error message;
in response to detecting the error message, identifying a failure condition associated with the error message;
generating a log associated with the failure condition;
transmitting the log to a power adapter, wherein the log is stored in a volatile memory of the power adapter;
subsequent to connecting a cable of the power adapter to another information handling system, collecting, by the another information handling system, the log stored in the volatile memory of the power adapter; and
subsequent to the collecting of the log from the power adapter, dialing a service center.

17. The non-transitory computer-readable medium of claim 16, wherein the transmitting of the log is performed via a vendor-defined message.

18. The non-transitory computer-readable medium of claim 16, wherein the operations further comprise encrypting the log prior to the transmitting of the log to the power adapter.

19. The non-transitory computer-readable medium of claim 16, wherein the operations further comprise retaining the log in the volatile memory of the power adapter while the power adapter is plugged into an alternating current power source.

20. The non-transitory computer-readable medium of claim 16, wherein the operations further comprise subsequent to the collecting of the log from the power adapter, transmitting the log to a remote server for storage.
